(19) United States
(12) Patent Application Publication
(10) Pub. No.: US 2014/0365906 A1
(43) Pub. Date: Dec. 11, 2014

(54) DISPLAYING PRE-DEFINED CONFIGURATIONS OF CONTENT ELEMENTS

(71) Applicant: Hewlett-Packard Development Company, L.P., Houston, TX (US)

(72) Inventors: Christopher Willis, Palo Alto, CA (US); Kevin Smathers, Hayward, CA (US); Henry Sang, JR., Cupertino, CA (US)

(21) Appl. No.: 13/914,344

(22) Filed: Jun. 10, 2013

(51) Int. Cl. G06F 3/0484; G06F 3/0481

(52) U.S. Cl. CPC G06F 3/04847; G06F 3/04817; G06F 3/04842
USPC 715/746

(57) ABSTRACT

A system and method for method for managing pre-defined configurations of content elements are described herein. In one example, the method can include storing a first pre-defined configuration of content elements with the modification in a clustered display system. The method can also include detecting a selection of a second pre-defined configuration of content elements. Additionally, the method can include generating an instruction to replace the first pre-defined configuration of content elements with the second pre-defined configuration of content elements. The method can also include loading the second pre-defined configuration of content elements in at least two clustered display systems. In addition, the method can include displaying the second pre-defined configuration of content elements in the at least two clustered display systems.

### BACKGROUND

In many control rooms and operation centers, a control system can manage and display information across a number of computing devices. In some examples, each computing device can be connected to a separate display device that can display various aspects of processes or complex industrial systems. For example, a control system may manage industrial processes by monitoring information from a number of programmable logic controllers and displaying the information using an application or system such as a supervisory control and data acquisition (also referred to herein as SCADA) system or a distributed control system (also referred to herein as DCS).

### BRIEF DESCRIPTION

Certain examples are described in the following detailed description and in reference to the drawings, in which:

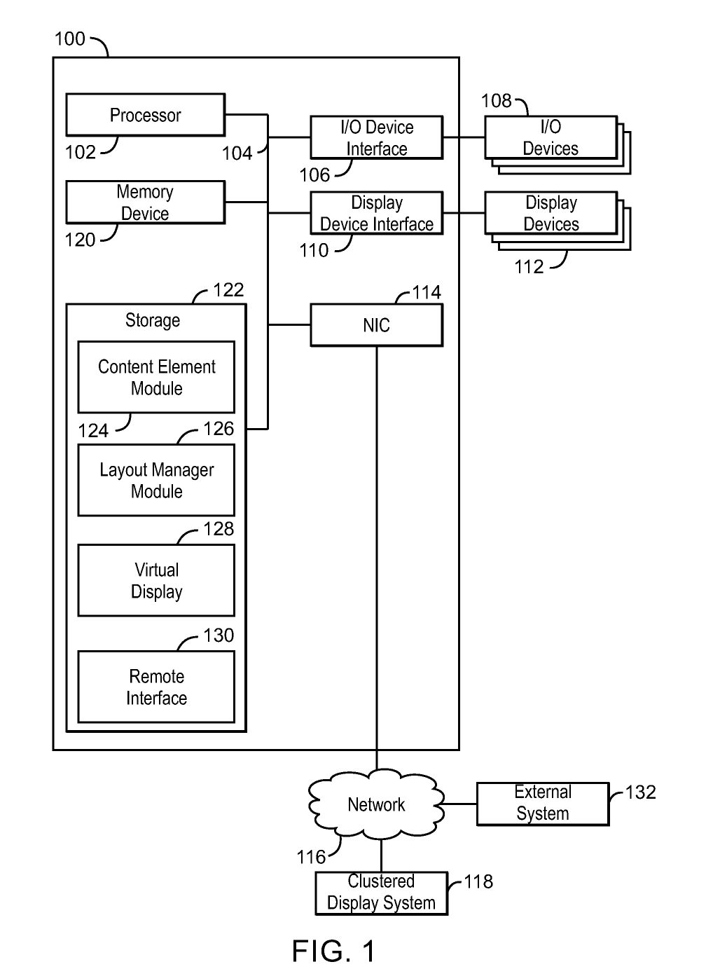

FIG. 1 is a block diagram of an example computing system that can display a pre-defined configuration of content elements;

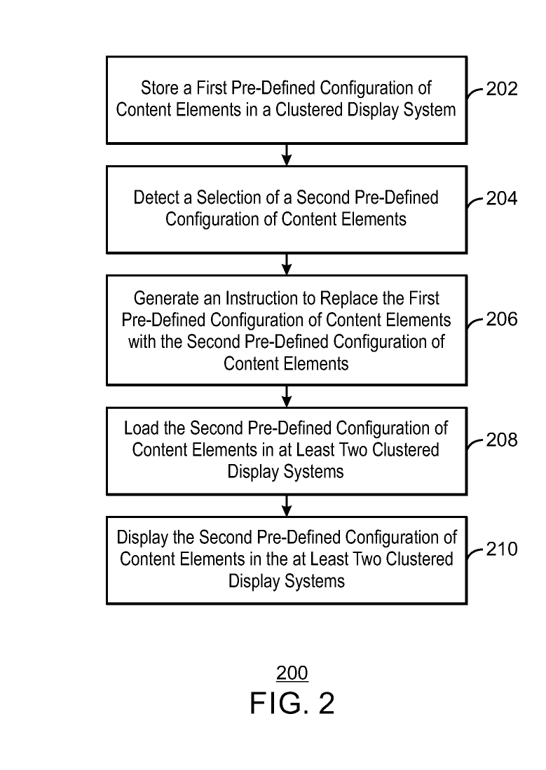

FIG. 2 is a process flow diagram of an example method that can display pre-defined configurations of content elements;

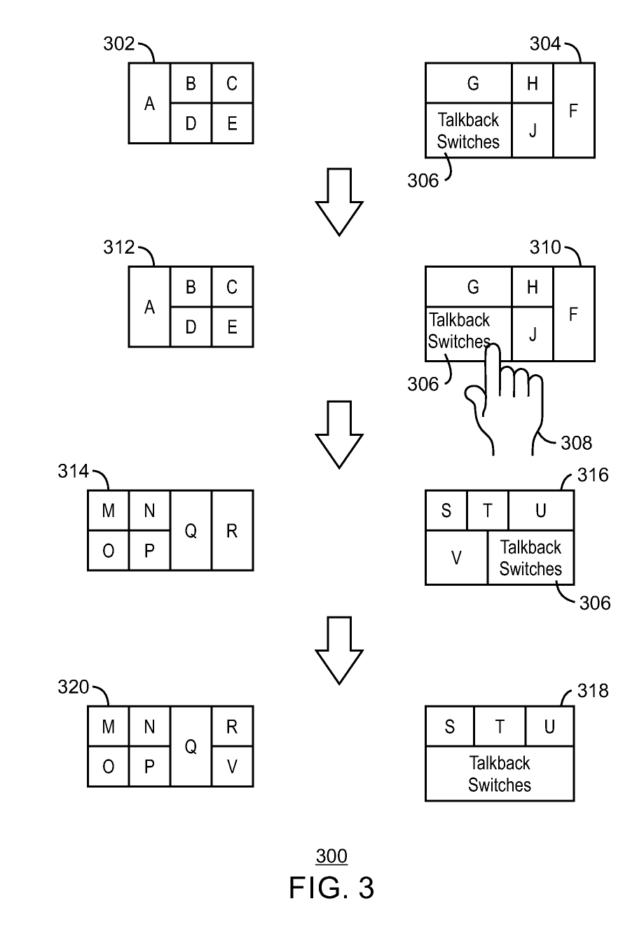

FIG. 3 is an example of a graphical user interface that displays a pre-defined configuration of content elements;

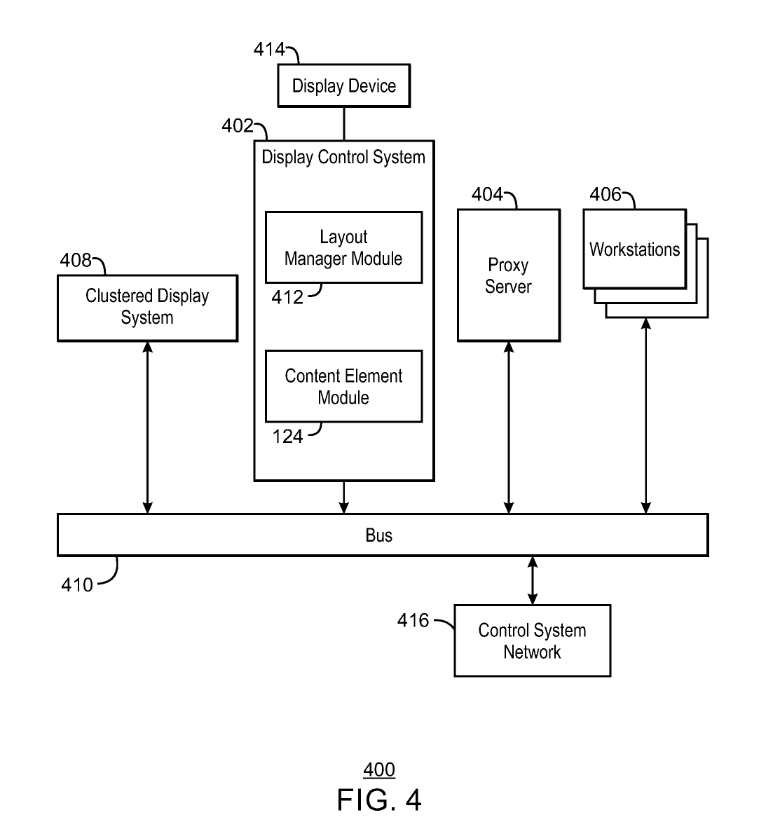

FIG. 4 is a block diagram of a networked cluster of systems that can collaboratively manage content elements coordinated over multiple displays; and

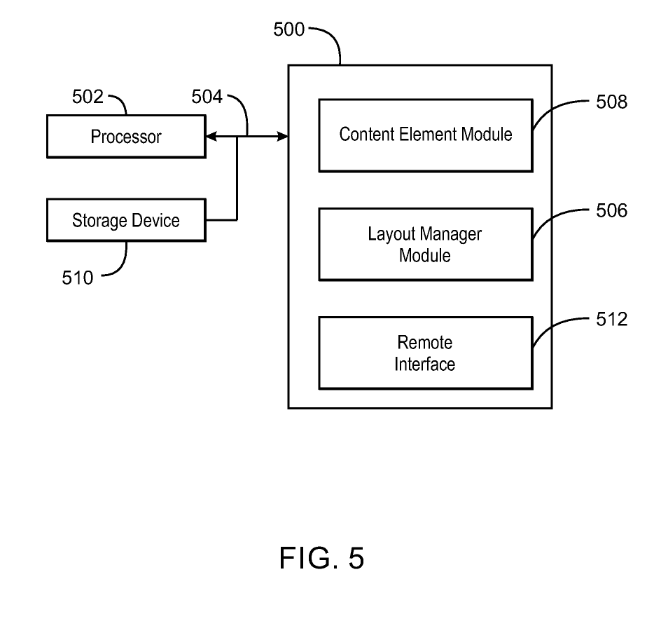

FIG. 5 is a block diagram depicting an example of a tangible, non-transitory computer-readable medium that can display pre-defined configuration of content elements.

### DESCRIPTION OF THE EXAMPLES

Many control systems use custom software to display information about various processes. In current systems, the custom display software is not reconfigurable, e.g., the information that will be displayed is determined at the time the control software is initially configured. Thus, to reconfigure the control software to add or remove information from a display device, the custom software is modified and redeployed. Therefore, the custom software is often limited to display information in a real time database embedded in a system.

According to examples of the subject matter described herein, pre-defined configurations of content elements (also referred to herein as layouts) can be stored, managed, and displayed. A layout, as referred to herein, can include any suitable pre-defined configuration of content elements within a clustered display system and/or a virtual display. A content element, as referred to herein, can include web based data, ActiveX® based data, application based data, process control data (such as sensor readings), digital images, digital video, remote desktop login data, and office documents, among others. In some examples, the layouts can be displayed in a clustered display system. A clustered display system, as referred to herein, can include any suitable number of display devices connected to any suitable number of computing devices. In some examples, a display device used with a clustered display system can be a multi-projector or multi-clustered display system covering an entire wall and may display any suitable number of content elements.

In some examples, layouts can also be displayed in a virtual display. A virtual display, as referred to herein, can pre-load any suitable number of content elements that are not to be displayed in a clustered display system. In some examples, a control system, such as the display control system 402 described below in relation to FIG. 4 or any suitable computing device, can manage layouts displayed in a clustered display system such as the clustered display system 408 described below in relation to FIG. 4, or loaded in a virtual display, or any combination thereof. For example, a layout may indicate a predefined set of content elements to display in a clustered display system or load in a virtual display. In some examples, a virtual display can pre-load content elements that are not to be displayed by a clustered display system. Therefore, users of the clustered display system may not be able to view the content elements in the virtual display. In some examples, the virtual display can provide a display cache, which enables users of a display control system 402 or any suitable computing device to load the information in content elements in the virtual display. In some examples, any suitable application, such as the layout manager module 126 described below in relation to FIG. 1, can also manage layouts arranged in a virtual display, a clustered display system, or any combination thereof.

In one example, the term virtual display includes a reserved section of the main memory of a computer system that can store data or content elements that is not accessible by a graphics processor. The computer system may also include a clustered display system that includes a memory that is accessible by both a central processing unit and by a graphics processor. The content elements in the memory of the clustered display system can be written by the CPU and displayed on a display device by the graphics processor. In this example, the virtual display enables users to pre-load content elements into the section of the main memory where the elements are stored but not displayed. The pre-loaded content elements may then be moved to the memory in the display device on demand. This reduces the load time when the content elements are moved from the virtual display to the clustered display system. To move a content element from a virtual display to a clustered display system, the content elements stored in the virtual display can be loaded into the clustered display system in response to the selection of an icon mapped to the virtual display. In some examples, the icon can be viewed through the clustered display system.

In some examples, a segment of a memory that is accessible by a graphics processor may not be used for display. This segment of memory can be considered to be a virtual or hidden display. Content elements that are written into this segment of memory are not shown by the graphics processor until desired. For example, upon the selection of an icon mapped to the virtual display, the graphics processor can shift the mapping of the memory to access the content elements in the virtual display.

In some examples, a computing device can also detect a set of gestures for controlling the content elements that are displayed in the clustered display system and loaded in the virtual display. For example, the set of gestures may enable rearrangement of content elements in the clustered display system, moving a content element from a virtual display to the clustered display system, and moving a content element from the clustered display system to the virtual display, among others. In some examples, a computing device can also include a layout manager module that can store and manage content elements so that the content elements can be displayed in the clustered display system and/or loaded in the virtual display.

FIG. 1 is a block diagram of an example computing system that can display a pre-defined configuration of content elements. The computing system 100 may include, for example, a server computer, a mobile phone, laptop computer, desktop computer, or tablet computer, among others. The computing system 100 may include a processor 102 that is adapted to execute stored instructions. The processor 102 can be a single core processor, a multi-core processor, a computing cluster, or any number of other appropriate configurations.

The processor 102 may be connected through a system bus 104 (e.g., AMBA®, PCI®, PCI Express®, Hyper Transport®, Serial ATA, among others) to an input/output (I/O) device interface 106 adapted to connect the computing system 100 to one or more I/O devices 108. The I/O devices 108 may include, for example, a keyboard and a pointing device, wherein the pointing device may include a touchpad or a touchscreen, among others. The I/O devices 108 may be built-in components of the computing system 100, or may be devices that are externally connected to the computing system 100.

The processor 102 may also be linked through the system bus 104 to a display device interface 110 adapted to connect the computing system 100 to display devices 112. The display devices 112 may include a display screen that is a built-in component of the computing system 100. The display devices 112 may also include computer monitors, televisions, or projectors, among others, that are externally connected to the computing system 100. Additionally, the processor 102 may also be linked through the system bus 104 to a network interface card (also referred to herein as NIC) 114. The NIC 114 may be adapted to connect the computing system 100 through the system bus 104 to a network 116. The network 116 may be a wide area network (WAN), local area network (LAN), or the Internet, among others. The network 116 can connect the computing system 100 to a clustered display system 118 that can display any suitable pre-defined configuration of content elements within any suitable number of display devices in the clustered display system 118.

The processor 102 may also be linked through the system bus 104 to a memory device 120. In some examples, the memory device 120 can include random access memory (e.g., SRAM, DRAM, eDRAM, EDO RAM, DDR RAM, RRAM®, PRAM, among others), read only memory (e.g., Mask ROM, EPROM, EEPROM, among others), non-volatile memory (PCM, STT_MRAM, ReRAM, Memristor), or any other suitable memory systems.

The processor 102 may also be linked through the system bus 104 to a storage device 122. The storage device 122 can include a content element module 124 and a layout manager module 126. In some examples, the content element module 124 can manage content elements visible through the clustered display system 118 and content elements that are loaded in a virtual display 128. In some examples, the storage device 122 can include the virtual display 128, which can store any suitable number of pre-loaded content elements. As discussed above, a content element can include web based data, ActiveX® based data, application based data, process control data (such as sensor readings), images, videos, remote desktop login data, and office documents, among others. In some examples, any number of content elements can be related or share a relationship. For example, a set of content elements may relate to an industrial process, or a set of content elements may share a common characteristic. In some examples, a set of content elements may be visible to any suitable number of users through a clustered display system 118. There may be additional content elements that are not visible to users through the clustered display system 118. The content element module 124 can load the content elements that are not visible through the clustered display system 118 into the virtual display 128. For example, the content element module 124 may determine that a first set of content elements are to be displayed through the clustered display system 118 and a second set of content elements are to be loaded into a virtual display 128. In some examples, the virtual display may be viewed through a remote interface 130 visible through the display devices 112. For example, a remote interface 130 may be any suitable application stored in the storage device 122 that enables a user to view icons in the display device 122 that correspond with content elements in the virtual display 128.

In some examples, the layout manager module 126 can manage a pre-defined configuration of content elements. For example, the layout manager module 126 can detect any suitable number of content elements that are to be displayed with any suitable orientation between the content elements. An orientation, as referred to herein, can describe the position that a first content element is to be displayed in relation to a second content element. In some examples, an orientation can indicate that a first content element is to be displayed above a second content element, below a second content element, or to the left or right of the second content element, among others. In some examples, an orientation can also indicate the aspect ratio (also referred to as size) of a content element that is to be displayed.

In some examples, the layout manager module 126 can also indicate the orientation of any suitable number of content elements within any suitable number of display devices in a clustered display system 118. For example, a layout may indicate that each display device in a clustered display system 118 is to display different content elements or a different orientation of content elements, among others. In some examples, the layout manager module 126 can also detect modifications to layouts and modify the aspect ratio of content elements displayed in the layout. For example, the layout manager module 126 may detect a change to an orientation or aspect ratio of content elements displayed in the clustered display system 118 and the layout manager module 126 may modify the display of the content elements accordingly. For example, the layout manager module 126 may modify the aspect ratio of additional content elements to prevent portions of content in the content elements from not being displayed.

In some examples, the layout manager module 126 can also enable the rearrangement of content elements that are displayed through the clustered display system 118 and loaded into the virtual display 128. For example, the layout manager module 126 can detect a drag and drop operation that indicates a content element in the virtual display 128 is to be moved to the clustered display system 118. In some examples, the layout manager module 126 can rearrange, or resize the content elements in the clustered display system 118 so that a content element from the virtual display 128 can be viewed without overlap in the clustered display system 118. In some examples, the layout manager module 126 can also display content elements that are moved from the virtual display 128 within particular display devices in the clustered display system 118. For example, the layout manager module 126 may display a content element in each display device in the clustered display system 118. Alternatively, the layout manager module 126 may display a content element spanning any suitable number of display devices in the clustered display system 118.

In some examples, the layout manager module 126 can manage data from an external system 132 through the network 116. The external system 132 can include a geographic information system (also referred to herein as GIS), a distributed control system, a direct digital control system, a control circuit such as a programmable logic controller, or a SCADA system, among others. In some examples, the external system 132 can provide process control data related to various sensors, wherein the process control data are to be displayed in a content element. For example, a layout manager module 126 may detect a configuration for process control data from an external system 132 and send the configuration of the process control data to a clustered display system 118. In some examples, the process control data can include a data point name that corresponds to control data. For example, the data point name can indicate a sensor that provides control data rather than the data received from the sensor.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional memory devices, video cards, additional network interfaces, etc.). Furthermore, any of the functionalities of the layout manager module 126 may be partially, or entirely, implemented in any suitable hardware component such as the processor 102. For example, the functionality may be implemented with an application specific integrated circuit, in logic implemented in the processor 102, in a memory device 120, in a video card, or in a co-processor on a peripheral device, among others.

FIG. 2 is a process flow diagram of an example method that can display pre-defined configurations of content elements. The method 200 can be implemented with any suitable computing device, such as the computing system 100 of FIG. 1.

At block 202, the layout manager module 126 can store a first pre-defined configuration of content elements in a clustered display system. As discussed above, a content element can include web based data, ActiveX® based data, application based data, process control data (such as sensor data), images, videos, remote desktop login data, and office documents, among others. A pre-defined configuration of content elements (also referred to herein as a layout) can indicate a number of content elements are to be displayed in a clustered display system and/or loaded into a virtual display. In some examples, the pre-defined configuration of content elements can also indicate the orientation of the content elements that are to be displayed. For example, the orientation can indicate the size of a content element to be displayed, or whether a first content element is to be displayed proximate a second content element, among others. In some examples, the layout manager module 126 can send the first pre-defined configuration of content elements to a clustered display system.

As discussed above, a clustered display system can include any suitable number of display devices. For example, a clustered display system may include a large wall sized display device, or a number of separate small display devices, or any combination thereof. Each display device of a clustered display system can display any suitable number of content elements. In some examples, content elements can be loaded into the virtual display, but not displayed in the clustered display system.

In some examples, the layout manager module 126 can store the first pre-defined configuration of content elements in response to user input following a modification. For example, the first pre-defined configuration of content elements may have content elements resized or rearranged as the first pre-defined configuration of content elements is displayed in a clustered display system. Additionally, content elements may be added to the first pre-defined configuration of content elements or content elements may be removed from the first pre-defined configuration of content elements. In some examples, storing the first pre-defined configuration of content elements can enable a user to view modifications that were detected during the previous display of the first pre-defined configuration of content elements. In some examples, the layout manager module 126 can automatically store the first pre-defined configuration of content elements prior to displaying a second pre-defined configuration of content elements.

At block 204, the layout manager module 126 can detect the selection of a second pre-defined configuration of content elements. In some examples, the layout manager module 126 can detect the selection of a second pre-defined configuration of content elements in a clustered display system and/or a remote interface associated with a virtual display. In some examples, a remote interface associated with a virtual display can include any suitable number of icons that are associated with content elements loaded into the virtual display. In some examples, the layout manager module 126 can detect a second pre-defined configuration of content elements using any suitable input gesture. For example, the layout manager module 126 may detect that a region of the remote interface associated with the virtual display or a display device in the clustered display system that displays a list of different pre-defined configurations of content elements has been touched for a predetermined period of time. In some examples, a pre-defined configuration of content elements can be selected with additional input gestures such as a mouse click, a drag and drop gesture, or a keyboard stroke, among others.

At block 206, the layout manager module 126 can generate an instruction to replace the first pre-defined configuration of content elements with the second pre-defined configuration of content elements. For example, the layout manager module 126 may generate an instruction that includes any suitable number of parameters. In some examples, the instruction can include parameters that indicate a display device that is to display a content element within a clustered display system, a filename that includes content that is to be displayed, or any other suitable source for a content element, among others. In some examples, the layout manager module 126 can generate the instruction in response to a drag and drop input gesture. For example, a drag and drop input gesture may indicate that a pre-defined configuration of content elements has been dragged from a remote interface associated with a virtual display and dropped in a clustered display system. In some examples, the drag and drop input gesture may also indicate a display device that is to display a pre-defined configuration of content elements.

In some examples, instructions can also indicate a pre-defined configuration of content elements that is to be displayed within any suitable number of display devices and/or loaded into a virtual display. For example, the pre-defined configuration of content elements may indicate that each display device in a clustered display system is to display separate sets of content elements. An example of a graphical user interface that displays a pre-defined configuration of content elements is described in greater detail below in relation to FIG. 3.

At block 208, the layout manager module 126 can load the second pre-defined configuration of content elements in at least two clustered display systems. In some examples, the two clustered display systems can stop displaying previously received pre-defined configuration of content elements in response to loading the second pre-defined configuration of content elements. For example, the first pre-defined configuration of content elements may no longer be visible in the two clustered display systems once the second pre-defined configuration of content elements has been loaded.

At block 210, the layout manager module 126 can display the second pre-defined configuration of content elements in at least two clustered display systems. In some examples, the layout manager module 126 can use the second pre-defined configuration of content elements to determine the location to display content elements. For example, as discussed above, the layout manager module 126 may modify or resize the region of a display device that displays a content element based on the second configuration of the content elements. In some examples, the content elements can be visible in a display device without overlapping.

In some examples, the layout manager module 126 can also determine the orientation of content elements based on the configuration of the content elements. For example, the configuration of the content elements can indicate that a second content element is to be displayed in the clustered display system adjacent to a first content element. In some examples, a second element may be displayed to the right or the left of a first content element. A second element may also be displayed above or below the first content element, or in any other suitable orientation to the first content element. In some examples, the second content element or the first content element may also have different aspect ratios. The second content element and the first content element may also be displayed in regions with different geometric shapes or borders. For example, the first content element may be displayed in the clustered display system in a circular region, while the second content element may be displayed in the clustered display system in a rectangular region.

In some examples, the layout manager module 126 can display the second pre-defined configuration of content elements by sending the second configuration to a clustered display system. The layout manager module 126 can also automatically display a second pre-defined configuration of content elements in response to an event. For example, the layout manager module 126 may detect an event such as an emergency, among others. The layout manager module 126 may automatically display a second pre-defined configuration of content elements, which can enable content elements with information related to the event to be displayed. In some examples, the layout manager module 126 can resize the second pre-defined configuration of content elements based on an aspect ratio or a display device resolution in the at least two clustered display systems.

The process flow diagram of FIG. 2 is not intended to indicate that the operations of the method 200 are to be executed in any particular order, or that all of the operations of the method 200 are to be included in every case. Further, any number of additional steps may be included within the method 200, depending on the specific application. For example, the layout manager module 126 may display two content elements in a pre-defined configuration of content elements by sending a first content element to a clustered display system and a second content element to a virtual display. Additionally, the layout manager module 126 may also display a first content element and a second content element by sending the first content element and the second content element to a clustered display system.

FIG. 3 is an example of a graphical user interface that displays a pre-defined configuration of content elements. The graphical user interface illustrated in FIG. 3 can be generated by any suitable computing device, such as the computing system 100 of FIG. 1. In some examples, a layout manager module 126 can generate the graphical user interface.

In some examples, the layout manager module 126 can generate a graphical user interface for a clustered display system that includes any suitable number of content elements. For example, the graphical user interface for a clustered display system 302 may include content elements A, B, C, D, and E. In some examples, the layout manager module 126 can also generate a graphical user interface (also referred to herein as a remote interface) for a virtual display 304 that includes any suitable number of content elements to be loaded, but not displayed in the clustered display system. For example, the graphical user interface for a virtual display 304 can include icons associated with content elements such as G, H, J, and F. The icons associated with the content elements displayed in the graphical user interface of the virtual display 304 can enable users to load content elements before moving the content elements to the graphical user interface for a clustered display system 302.

The layout manager module 126 can also display talkback switches 306. In some examples, the talkback switches 306 can be displayed in the clustered display system or a remote interface for a virtual display. The talkback switches 306 can indicate which pre-defined configuration of content elements is currently being displayed. In some examples, the talkback switches 306 can be buttons, which may be selected by any suitable user input such as a mouse click, among others. Each talkback switch 306 can correspond to a command that can include whether to load a new layout, a display device or display device group to display the layout, and a filename of the layout to be loaded. In some examples, the talkback switches 306 can include a set of colored lights that respond when a control system reacts to a command to change from a first layout to a second layout. For example the talkback switches 306 may change from a first color to a second color in the event that a particular layout is loaded. This feedback mechanism allows a display control system operator positive feedback that a command has been processed even though the clustered display system affected may not be within the operator's visibility. In some examples, the layout manager module 126 can detect the selection of a pre-defined configuration of content elements for a virtual display or a clustered display system. For example, a cursor 308 may select a pre-defined configuration of content elements from a list of different configurations displayed in the graphical user interface of the virtual display 310 or clustered display system 312. In some examples, the layout manager module 126 can control changes to a pre-defined configuration of content elements if a configuration is selected with a mouse, a keyboard stroke, or any suitable gesture in a touchpad or touchscreen device.

In some examples, the layout manager module 126 can display the selected pre-defined configuration of content elements by replacing the previously displayed pre-defined configuration of content elements. For example, the layout manager module 126 may replace the content elements displayed in the clustered display system with different content elements. In one example, the content elements A, B, C, D, and E displayed in the clustered display system 312 may be replaced with content elements M, N, O, P, Q, and R displayed in the clustered display system 314. In some examples, the layout manager module 126 can also replace the icons associated with content elements displayed in the virtual display. For example, the icons associated with content elements G, H, F, and J may be replaced so that the icons associated with content elements S, T, U, and V are displayed in the virtual display 316. Additionally, the layout manager module 126 can display the talkback switches 306 in different orientations to content elements based on the selected configuration of the clustered display system and virtual display. The layout manager module 126 may also detect an indicator in a layout that indicates a set of display devices in the clustered display system that is to display the content elements.

In some examples, the layout manager module 126 can also detect that the pre-defined configuration of content elements has been modified. For example, the layout manager module 126 can detect that a content element in the virtual display has been moved to the clustered display system 320. In one example, the layout manager module 126 can detect that a content element V has been moved from a virtual display to a clustered display system 320. In some examples, the layout manager module 126 can detect the modification to the pre-defined configuration of content elements and store the modification in a storage device. The layout manager module 126 can restore the modified pre-defined configuration of content elements when the modified configuration is selected for display.

It is to be understood that the graphical user interfaces illustrated in FIG. 3 are for illustrative purposes and are not intended to indicate that the graphical user interfaces are to include certain content elements. Rather, the graphical user interface of the clustered display system and virtual display can display any suitable number of content elements. Furthermore, the graphical user interface of the clustered display system and virtual display can display content elements in any suitable configuration within any suitable number of rows and columns. In some examples, the graphical user interface of the clustered display system and the remote interface can be displayed together in a control display.

FIG. 4 is a block diagram of an example of a networked cluster of systems that can collaboratively manage content elements coordinated over multiple displays. The systems can include a display control system 402, a proxy server 404, workstations 406, and a clustered display system 408. In some examples, the display control system 402, the proxy server 404, and any suitable number of workstations 406 can be connected by a bus 410. The bus 410 can include any suitable interconnect fabric that can transmit data.

The clustered display system 408 can display any suitable number of content elements within any suitable number of display devices. In some examples, the clustered display system 408 can receive content elements from a layout manager module 412 in a display control system 402. The layout manager module 412 can arrange the location, scale (also referred to herein as zoom), and display area (also referred to herein as size) of content elements. In some examples, the content elements displayed in the clustered display system 408 may not overlap and each of the content elements may be visible within a display device in the clustered display system 408. As discussed above, the content elements can include data from various sources. For example, content elements can include data from sources such as web based content visible through a browser, embeddable ActiveX® controls such as media players for displaying streaming or stored audio or video content, remote desktop sessions, and other applications that provide ActiveX® controls for display, among others. In some examples, the layout manager module 412 can also include data from any suitable application that includes an automation interface. For example, the layout manager module 412 may include data from applications such as word processors, which can be embedded in a content element by invoking an automation interface along with an application window capture.

In some examples, the layout manager module 412 can determine a display size for any suitable number of content elements, so that each content element is fully displayed without sacrificing the geometric shape of the content elements. For example, the layout manager module 412 may determine an aspect ratio for each content element, scale each content element, and place successively smaller content elements in the remaining available space of a display device. Alternatively, the layout manager module 412 may perform a recursive binary search for the size of each content element that results in the content elements being visible within a predetermined display size.

In some examples, the clustered display system 408 can display content elements using a pre-defined configuration of content elements or layouts. As discussed above, a layout can include any suitable arrangement of content elements in any suitable number of rows and columns. In some examples, the layout can be described in a form that includes windows presentation foundation data, form controls, ActiveX® controls, or application windows, among others. The layouts can describe the location, size, and scale of each content element. In some examples, the layouts can be converted into a format that can be saved and restored so that layouts can be replaced when switching the configuration of a display device.

In some examples, a display control system 402 can include any suitable number of modules that can manage the pre-defined configuration of content elements displayed in the clustered display system 408. For example, the display control system 402 may include a layout manager module 412 that can manage layouts. In some examples, the layout manager module 412 may display a list of layouts and detect the selection of a layout that is to replace the current pre-defined configuration of content elements displayed in the clustered display system 408 and loaded into the virtual display. In some examples, the layout manager module 412 can generate an instruction to display content elements included in the selected layout and send the instruction to the clustered display system 408. The clustered display system 408 can replace the displayed content elements with the content elements in the selected layout. In some examples, the layout display module 126 can also detect modifications to the layout from the content element module 124 and store the modifications to the layout.

In some examples, the display control system 402 can also include a content element module 124, which can manage any number of content elements. In some examples, the content element module 124 can detect the selection of a content element from a display device 414. For example, the content element module 124 may detect a “Drag and Drop” instruction, which indicates that a region of a display device 414 has been selected and dropped into a separate display device. In some examples, the Drag and Drop instruction can include a source content element and a destination location in which to display the source content element.

In some examples, the workstations 406 can create one or more windows that accept drag and drop requests and forward data to the layout manager module 412 and the content element module 124 in the display control system 402. For example, the workstations 406 may create windows that can accept any suitable content that is to be displayed in a content element such as a file from the desktop, or a URL from a web browser, among others. In some examples, the windows can accept a drag and drop request in an area at the edge of a display device, or any other suitable location within a display device. The windows can also copy the content to a content element module 124. In some examples, the content element module 124 can send a command to the clustered display system 408 indicating that the content element is to be displayed. In some examples, the command can also indicate a location within a display device in the clustered display system 408 to display the content element. For example, the command may indicate that the content element is to be displayed adjacent to related content elements. In some examples, the layout manager module 412 can also receive the command related to the modification of content elements displayed in the clustered display system 408 and the virtual display. The layout manager module 412 may store the modification to the current layout that is displayed in the clustered display system 408.

In some examples, a control system network 416 can provide process control data through the bus 410 to the display control system 402. The control system network 416 can include a geographic information system, a distributed control system, a direct digital control system, a programmable logic controller, or a SCADA system, among others. In some examples, the control system network 416 can provide data related to various sensors, wherein the data are to be displayed in a content element. For example, a layout manager module 412 may detect a configuration for process control data from a control system network 416 and send the configuration for the process control data to a clustered display system 408. In some examples, the display control system 402 may not receive data from a control system network 416. Alternatively, the display control system 402 may detect data to include in a pre-defined configuration of content elements from additional networks, or computing devices, among others.

It is to be understood that the block diagram of FIG. 4 is not intended to indicate that the systems illustrated in FIG. 4 are to include all of the components shown in FIG. 4. Rather, systems can include fewer or additional components not illustrated in FIG. 4 (e.g., additional memory devices, video cards, additional network interfaces, etc.). In some examples, the display control system 402, the proxy server 404, and the workstation 406 can include a content element module 124 that manages content elements and a layout manager module 412 that manages pre-defined configurations of content elements.

In some examples, the proxy server 404 can include the content element module 124, which can be any suitable web service. The proxy server 404 can provide access to the bus 410 from a web accessible application protocol interface, such as representational state transfer (also referred to herein as REST). In some examples, data related to content elements and layouts can be encapsulated in messages that can be sent from the workstations 406 and the display control system 402 to the clustered display system 408 using any suitable internet protocol. For example, the messages can be transmitted using POST or GET requests in any suitable markup language, such as XML, or any suitable standard for data exchange, such as JSON, among others. In some examples, when messages reference files such as images that are located on shared storage devices, the references can be replaced. For example, the references may be replaced with uniform resource locators (also referred to herein as URLs) along with a server interface to the referenced data. In some examples, the application protocol interface can include an initial handshake between a workstation 406 or display control system 402 and the proxy server 404. The proxy server 404 may provide a session identifier in response to the handshake, which can enable the proxy server 404 and the display control system 402 or the workstation 406 to send messages bi-directionally with encoded documents. In some examples, the messages can be encoded in XML documents.

FIG. 5 is a block diagram depicting an example of a tangible, non-transitory computer-readable medium that can display pre-defined configuration of content elements. The tangible, non-transitory, computer-readable medium 500 may be accessed by a processor 502 over a computer bus 504. Furthermore, the tangible, non-transitory, computer-readable medium 500 may include computer-executable instructions to direct the processor 502 to perform the steps of the current method.

The various software components discussed herein may be stored on the tangible, non-transitory, computer-readable medium 500, as indicated in FIG. 5. For example, a layout manager module 506 can manage a pre-defined configuration of content elements or layouts in a clustered display system and/or a virtual display. In some examples, the layout manager module 506 can also store modifications to the pre-defined configuration of content elements detected from the content element module 508 in a storage device 510 that is connected to the processor 502 through the computer bus 504. In some examples, the content element module 508 can manage modifications to the content elements displayed within a layout. In some examples, a remote interface 512 can display icons associated with content elements stored in a virtual display. The remote interface 512 can enable the content element module 508 to detect selected content elements loaded in the virtual display. In some examples, the content elements loaded in the virtual display can be stored in the storage device 510. It is to be understood that any number of additional software components not shown in FIG. 5 may be included within the tangible, non-transitory, computer-readable medium 500, depending on the specific application.

The present examples may be susceptible to various modifications and alternative forms and have been shown only for illustrative purposes. Furthermore, it is to be understood that the present techniques are not intended to be limited to the particular examples disclosed herein. Indeed, the scope of the appended claims is deemed to include all alternatives, modifications, and equivalents that are apparent to persons skilled in the art to which the disclosed subject matter pertains.

What is claimed is:

1. A method for displaying pre-defined configurations of content elements comprising:
storing a first pre-defined configuration of content elements in a clustered display system;
detecting a selection of a second pre-defined configuration of content elements;
generating an instruction to replace the first pre-defined configuration of content elements with the second pre-defined configuration of content elements;
loading the second pre-defined configuration of content elements in at least two clustered display systems; and
displaying the second pre-defined configuration of content elements in the at least two clustered display systems.

2. The method of claim 1, wherein the first pre-defined configuration of content elements and the second pre-defined configuration of content elements each comprise an orientation between at least two content elements.

3. The method of claim 1, comprising:
detecting a selection of a talkback switch that corresponds with the second pre-defined configuration of content elements; and
displaying the second pre-defined configuration of content elements in the clustered display system in response to the selection of the talkback switch that corresponds with the second pre-defined configuration of content elements.

4. The method of claim 1, comprising resizing the second pre-defined configuration of content elements based on an aspect ratio or a display device resolution in the at least two clustered display systems.

5. The method of claim 1, wherein the second pre-defined configuration of content elements comprises icons associated with a virtual display.

6. The method of claim 1, wherein the content elements comprise process control data from a control system.

7. The method of claim 6, wherein the control system comprises one of a geographic information system, a distributed control system, a direct digital control system, a control circuit, or a supervisory control and data acquisition system.

8. A system for displaying a pre-defined configuration of content elements comprising:
a layout manager module to provide instructions that manage the pre-defined configuration of content elements; and
a processor to execute the instructions provided by the layout manager module, wherein the instructions direct the processor to:
store a first pre-defined configuration of content elements in a clustered display system;
detect a selection of a second pre-defined configuration of content elements;
generate an instruction to replace the first pre-defined configuration of content elements with the second pre-defined configuration of content elements;
load the second pre-defined configuration of content elements in at least two clustered display systems; and
display the second pre-defined configuration of content elements in the at least two clustered display systems.

9. The system of claim 8, wherein the first pre-defined configuration of content elements and the second pre-defined configuration of content elements each comprise an orientation between at least two content elements.

10. The system of claim 8, wherein the instructions direct the processor to resize the second pre-defined configuration of content elements based on an aspect ratio or a display device resolution in the at least two clustered display systems.

11. The system of claim 8, wherein the instructions direct the processor to:
detect a selection of a talkback switch that corresponds with the second pre-defined configuration of content elements; and
display the second pre-defined configuration of content elements in the clustered display system in response to the selection of the talkback switch that corresponds with the second pre-defined configuration of content elements.

12. The system of claim 8, wherein the first pre-defined configuration of content elements and the second pre-defined configuration of content elements are arranged, in part, on a remote interface to a virtual display.

13. The system of claim 8, wherein the content elements comprise process control data from a control system.

14. The system, of claim 13, wherein the control system comprises one of a geographic information system, a distributed control system, a direct digital control system, a control circuit, or a supervisory control and data acquisition system.

15. A non-transitory, computer-readable medium comprising a plurality of instructions that, in response to being executed on a computing device, cause the computing device to:
store a first pre-defined configuration of content elements with the modification in a clustered display system;
detect a selection of a second pre-defined configuration of content elements;
generate an instruction to replace the first pre-defined configuration of content elements with the second pre-defined configuration of content elements;
load the second pre-defined configuration of content elements in at least two clustered display systems; and
display the second pre-defined configuration of content elements in the at least two clustered display systems.

16. The non-transitory, computer-readable medium 15, wherein the first pre-defined configuration of content elements and the second pre-defined configuration of content elements each comprise an orientation between at least two content elements.

17. The non-transitory, computer-readable medium 15, wherein the plurality of instructions, in response to being executed on a computing device, cause the computing device to:
detect a selection of a talkback switch that corresponds with the second pre-defined configuration of content elements; and
display the second pre-defined configuration of content elements in the clustered display system in response to the selection of the talkback switch that corresponds with the second pre-defined configuration of content elements.

18. The non-transitory, computer-readable medium of claim 15, wherein the plurality of instructions, in response to being executed on a computing device, cause the computing device to arrange the second pre-defined configuration of content elements in a remote interface to a virtual display in the clustered display system.

19. The non-transitory, computer-readable medium of claim 15, wherein the content elements comprise process control data from a control system.

20. The non-transitory, computer-readable medium of claim 19, wherein the control system comprises one of a geographic information system, a distributed control system, a direct digital control system, a control circuit, or a supervisory control and data acquisition system.
